(19) United States
(12) Patent Application Publication
(10) Pub. No.: US 2026/0259546 A1
(43) Pub. Date: Sep. 3, 2026

(54) DYNAMICALLY CREATED DIES FOR THREE-DIMENSIONAL (3D) PRINTING

(71) Applicant: INTERNATIONAL BUSINESS MACHINES CORPORATION, Armonk, NY (US)

(72) Inventors: Randy A. Rendahl, Raleigh, NC (US); Carolina Garcia Delgado, Zapopan (MX); Tushar Agrawal, West Fargo, ND (US); Sarbajit Kumar Rakshit, Kolkata (IN)

(21) Appl. No.: 19/067,269

(22) Filed: Feb. 28, 2025

(51) Int. Cl. G05B 19/4099

(52) U.S. Cl. CPC G05B 19/4099; G05B 2219/49023

(57) ABSTRACT

A method, system, and computer program product configured to perform operations including: receiving a three-dimensional (3D) print file comprising a plurality of physical attributes describing an object to be 3D printed; determining a first set of die definitions describing a first die, where the first die definitions are determined based on at least a portion of the 3D print file; obtaining a first die based on the determined first set of die definitions; casting a first portion of the object using the first die; and printing, using a 3D printer, a second portion of the object, where the second portion is printed on top of the first portion.

### BACKGROUND

Aspects of the present invention relate generally to methods, systems, and computer program products for runtime positioning of dynamically created dies while printing a 3D object.

Three-dimensional (3D) printing, or additive manufacturing, is a process of making solid 3D objects from a digital file. In general, this process is executed layer by layer and the time required to complete this 3D printing process depends on the size and complexity of the printing item.

### SUMMARY

In a first aspect of the invention, there is a method including: receiving a three-dimensional (3D) print file comprising a plurality of physical attributes describing an object to be 3D printed; determining a first set of die definitions describing a first die, wherein the first die definitions are determined based on at least a portion of the 3D print file; obtaining a first die based on the determined first set of die definitions; casting a first portion of the object using the first die; and printing, using a 3D printer, a second portion of the object, wherein the second portion is printed on top of the first portion.

In another aspect of the invention, there is a computer program product comprising one or more computer-readable storage media and program instructions stored on the one or more computer-readable storage media to perform operations comprising: receiving a three-dimensional (3D) print file comprising a plurality of physical attributes describing an object to be 3D printed; determining a first set of die definitions describing a first die, wherein the first die definitions are determined based on at least a portion of the 3D print file; obtaining a first die based on the determined first set of die definitions; casting a first portion of the object using the first die; and printing, using a 3D printer, a second portion of the object, wherein the second portion is printed on top of the first portion.

In another aspect of the invention, there is a computer system comprising a processor set, one or more computer-readable storage media, and program instructions stored on the one or more computer-readable storage media to cause the processor set to perform operations comprising: receiving a three-dimensional (3D) print file comprising a plurality of physical attributes describing an object to be 3D printed; determining a first set of die definitions describing a first die, wherein the first die definitions are determined based on at least a portion of the 3D print file; obtaining a first die based on the determined first set of die definitions; casting a first portion of the object using the first die; and printing, using a 3D printer, a second portion of the object, wherein the second portion is printed on top of the first portion.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment in accordance with aspects of the present invention.

FIG. 3 shows a flowchart of an exemplary method in accordance with aspects of the present invention.

FIG. 4 shows a flowchart of an exemplary method in accordance with aspects of the present invention.

### DETAILED DESCRIPTION

Aspects of the present invention relate generally to methods, systems, and computer program products for runtime positioning of dynamically created dies while printing a 3D object. In conventional systems, 3D printing nozzles generally print objects in a layer-by-layer fashion for the duration of the printing process. This conventional process often takes a relatively long time to manufacture (e.g., print) the object. Conventional casting methods (e.g., die casting) are comparatively faster when it comes to manufacturing. However, when casting, a die and/or mold is needed for casting and creating and/or finding an appropriate die and/or mold may create difficulties. Therefore, the lengthy 3D printing process and difficulties in obtaining an appropriate die and/or mold create problems for manufacturers.

Implementations of the invention address this problem by providing a method, system, and computer program product that can manufacture portions of an object using 3D printing methods and that can dynamically create dies and/or molds for casting other portions of the object. For example, In accordance with aspects of the instant invention, the methods, systems, and computer program products disclosed herein may identify portions of a 3D object that can be manufactured using casting methods and portions of a 3D object that can be manufactured with 3D printing process, to optimize time and resources. Various embodiments leverage one or more robotic arms to dynamically create dies or molds with appropriate shapes, dimensions, materials, and/or properties. In this manner, embodiments provide an improved method for combining the benefits of both 3D printing and casting processes, thereby optimizing manufacturing time and resource usage. Specifically, by identifying portions of a 3D object that are best suited for casting and portions that are best suited for 3D printing, the system can streamline production, reduce costs, and speed up the overall manufacturing process. For example, complex or intricate features of an object that would be time-consuming or difficult to mold could be produced using 3D printing. Meanwhile, less complex, smaller, or more customized portions of the object could be produced using casting techniques for faster turnaround times and greater precision.

Furthermore, by leveraging robotic arms or other automated machinery, the methods, systems, and computer program products disclosed herein can dynamically switch between manufacturing methods, ensuring that the appropriate technology is used for each part of the object. This hybrid approach not only reduces time but also enhances the efficiency and quality of the final product, as each portion is produced using the most suitable method.

According to an aspect of the present invention, the method, system, and computer program product include: leveraging flexible strips (i.e., thin metal sheets) to create dies around an object being 3D printed; utilizing the dies based on a shape and dimensions of the object; creating a knowledge corpus of dies based on parameters such as a quantity of the object, materials used to make the object, a shape and size of the object, and a precision required in making the object; and controlling robotic arms to grip the dies and to position a first die of the dies at an appropriate location on the object; pouring a heated filament material into the first die and allowing the heated filament material to solidify on the object; and causing the robotic arms to remove the first die upon the solidification of the filament material.

In embodiments, the leveraging the flexible strips to create the dies further includes utilizing the robotic arms to manipulate the flexible strips to into a specified shape.

In embodiments, the creating the knowledge corpus of the dies further includes utilizing historical data in the knowledge corpus to identify an appropriate die during the 3D printing.

Implementations of the present invention are necessarily rooted in computer technology. For example, receiving a 3D print file comprising a plurality of physical attributes describing an object to be 3D printed; determining a first set of die definitions describing a first die; obtaining a first die based on the determined first set of die definitions; casting a first portion of the object using the first die; and printing, using a 3D printer, a second portion of the object are computer-based and cannot be performed in the human mind.

It should be understood that, to the extent implementations of the present invention collect, store, or employ personal information provided by, or obtained from, individuals (e.g., individual and/or personal information captured when scanning a surface), such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as novel 3D object creation code of block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

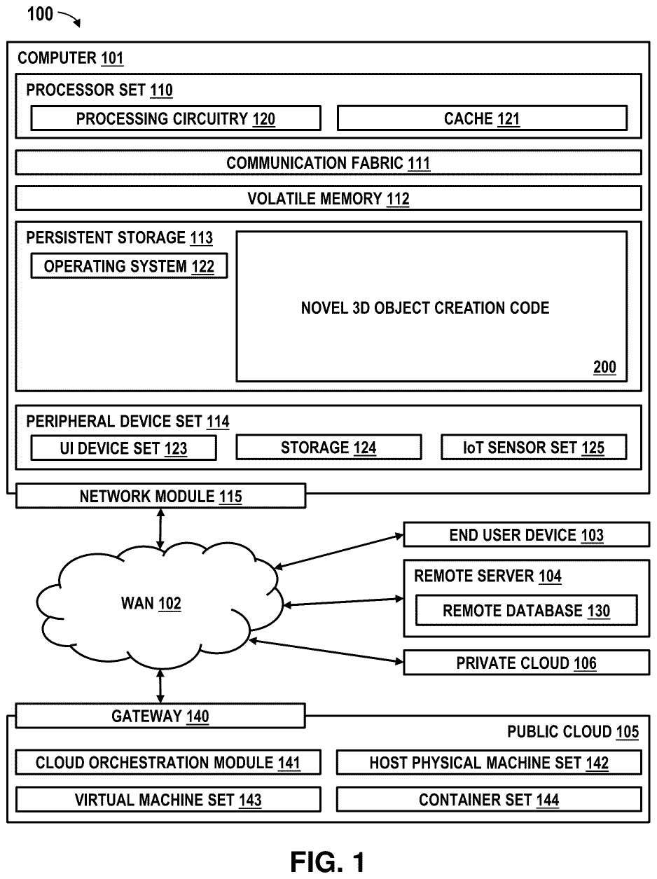

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not Separately Shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

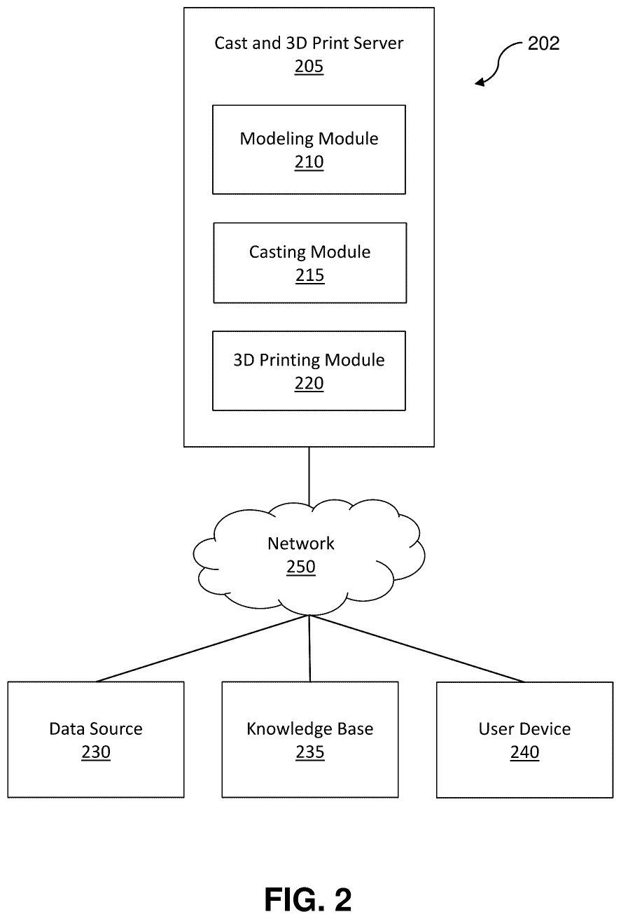

FIG. 2 shows a block diagram of exemplary environment 202 in accordance with aspects of the present invention. In embodiments, environment 202 includes cast and 3D print server 205, data source 230, knowledge base 235, user device 240, and network 250.

Cast and 3D print server 205 may comprise one or more instances of computer 101 of FIG. 1. In another example cast and 3D print server 205 may comprise one or more virtual machines or containers running on one or more instances of computer 101 of FIG. 1. In embodiments, cast and 3D print server 205 communicates with data source 230, knowledge base 235, and user device 240 via network 250, which may comprise WAN 102 of FIG. 1. In embodiments, data source 230 may comprise one or more data sources each comprising an instance of remote database 130 and/or remote server 104 of FIG. 1. In embodiments, knowledge base 235 may comprise one or more data sources each comprising an instance of remote database 130 and/or remote server 104 of FIG. 1. In embodiments, user device 240 comprises an instance of EUD 103 of FIG. 1. There may be plural different instances of user device 240 including, for example, personal computing devices and/or any other device useful for generating and or storing spatial computing information as disclosed herein. The different instances of user device 240 may be used by different users, evaluators, operators, technicians, etc.

In embodiments, cast and 3D print server 205 of FIG. 2 comprises modeling module 210, casting module 215, and 3D printing module 220, each of which may comprise modules of the code of block 200 of FIG. 1. Such modules may include routines, programs, objects, components, logic, data structures, and so on that perform a particular task (or tasks) or implement a particular data type (or types) that the code of block 200 uses to carry out the functions and/or methodologies of embodiments of the present invention as described herein. These modules of the code of block 200 are executable by computer 101 of FIG. 1 (e.g., processing circuitry 120 of FIG. 1) to perform the inventive methods as described herein. Cast and 3D print server 205 may include additional or fewer modules than those shown in FIG. 2. In embodiments, separate modules may be integrated into a single module. Additionally, or alternatively, a single module may be implemented as multiple modules. Moreover, the quantity of devices and/or networks in the environment is not limited to what is shown in FIG. 2. In practice, the environment may include additional devices and/or networks; fewer devices and/or networks; different devices and/or networks; or differently arranged devices and/or networks than illustrated in FIG. 2.

In accordance with aspects of the present invention, cast and 3D print server 205 is configured to facilitate communication between modeling module 210, casting module 215, 3D printing module 220, and external storage (e.g., data source 230 and/or knowledge base 235) and devices (e.g., user device 240) via network 250. For example, in embodiments, cast and 3D print server 205 may receive, access, and/or obtain the 3D print file describing an object to be 3D printed from external storage (e.g., data source 230 and/or knowledge base 235).

In accordance with aspects of the present invention, modeling module 210 is configured to scan a pre-manufactured object to determine physical attributes of the pre-manufactured object. As used herein, scanning refers to the process of capturing the shape, dimensions, surface texture, color information, geometry accuracy, surface smoothness, surface contours, and/or other relevant physical properties of the object. In embodiments, modeling module 210 performs that scanning using a laser scanning techniques, cameras, structured light, photogrammetry, and/or any other scanning technology capable of capturing the shape and dimensions of an object. As used herein, a pre-manufactured object refers to an object that has been created, fabricated, and/or assembled prior to the scanning process. In embodiments, the pre-manufactured object may be a 3D printed object.

In embodiments, modeling module 210 is configured to analyze the scan data associated with the pre-manufactured object to determine scan resolution, scan noise, scan artifacts, areas of reflectivity, areas of transparency, scan scale, scan proportions, and other factors that may negatively affect the quality of the scan. In such embodiments, modeling module 210 may filter and/or modify the scan data based on the analysis, by removing or correcting errors, smoothing surfaces, adjusting scale, and enhancing resolution or detail where necessary.

In embodiments, modeling module 210 is configured to generate a 3D print file comprising the plurality of physical attributes describing an object to be 3D printed based on the scanning results. In other words, modeling module 210 is configured to generate a 3D print file by processing the scan data to create a digital 3D model, which includes the object's shape, dimensions, surface texture, and other relevant attributes, and then converting this model into a file format suitable for 3D printing (e.g., stereolithography file (STL), object file (OBJ), and/or additive manufacturing file (AMF)). In embodiments, the 3D print file may be stored locally and/or in an external storage (e.g., data source 230 and/or knowledge base 235).

In embodiments, modeling module 210 may generate a 3D print file for the object to be 3D printed, where the 3D print file specifies multiple zones for creating the 3D object. For example, modeling module 210 may generate a 3D print file having three separate zones. In embodiments, modeling module 210 may specify that the process for creating the 3D object is faster, more efficient, and/or cheaper if zones 1 and 3 are produced using casting methods and zone 2 is produced using 3D printing methods. In other embodiments, modeling module 210 may specify that the process for creating the 3D object is faster, more efficient, and/or cheaper if zones 1 and 2 are produced using casting methods and zone 3 is produced using 3D printing methods. Additional variations are possible, where the zones may be assigned different manufacturing methods based on factors such as material properties, desired part performance, and cost optimization. For instance, zone 1 could be produced using injection molding, zone 2 using 3D printing for more complex geometries and/or custom features, and zone 3 could use traditional machining methods for fine tolerances or surface finishes. The specific combination of manufacturing techniques may vary depending on the design specifications and the trade-offs between speed, cost, and quality. Additionally, modeling module 210 may include functionality to dynamically adjust the selection of manufacturing methods based on real-time cost data or material availability, further enhancing the efficiency of the 3D object production process. Furthermore, modeling module 210 may consider the number of objects to be created and/or the repetitiveness of the operations. For example, if 3D printing one object in its entirety is cheaper and/or faster than die casting a portion of the object and 3D printing a portion of the object, and only one object is needed, modeling module 210 may determine to only 3D print the object. However, modeling module 210 may determine that after making ten objects, for example, the combination of casting and 3D printing becomes cheaper and/or faster, modeling module 210 may determine to cast and 3D print the ten (or more) objects to save time and resources.

In accordance with aspects of the present invention, casting module 215 is configured to determine, identify, and/or receive a set of die definitions describing a die (e.g., a mold) for casting based on at least a portion of the 3D print file generated by modeling module 210. As used herein a die definition refers to a detailed specification that describes the physical characteristics, shape, dimensions, and features of a die and/or mold used in the casting process. It may include information such as material requirements, cavity design, gating system, and other factors for creating a die that can produce the desired cast object based on the 3D model and/or a 3D print file. The die definitions may also include specific lengths, angles, tolerances, draft angles, surface finish requirements, venting designs, and core placements. These factors ensure that the die is correctly designed to produce high-quality castings that match the desired specifications and are manufacturable within the constraints of the casting process. In embodiments, casting module 215 may obtain the die definitions from memory (e.g., one or more instances of data source 230 and/or knowledge base 235). In embodiments, casting module 215 may also store the die definitions in memory (e.g., one or more instances of data source 230 and/or knowledge base 235) for retrieval and/or use at a future time or by a third-party manufacturer.

In embodiments where casting module 215 determines the die definitions, casting module 215 may be configured to determine step-by-step instructions for turning a malleable substrate into a die or mold that meets the specifications of the die definitions. In other words, casting module 215 may be configured to generate a detailed process plan or workflow for manufacturing the die or mold based on the die definitions. This process may involve various steps such as selecting appropriate materials, machining, modifying, or forming the substrate to achieve the desired shape and dimensions, adding any necessary features (such as gating systems or cooling channels), and applying finishing processes to meet surface quality and tolerance requirements. In embodiments, the step-by-step instructions may include steps to be taken by one or more robotic arms to ensure accurate shaping, applying the necessary forces and movements to form the substrate into the mold or die with the correct dimensions, angles, and features needed for the casting process.

In embodiments, casting module 215 is configured to generate, obtain, and/or receive a die based on the determined set of die definitions. In embodiments, the die is generated using one or more robotic arms and a malleable substrate based on the die definitions. Specifically, the robotic arms may be used to manipulate the malleable substrate by shaping it according to the die definitions. In embodiments, the malleable substrate can be a material that can be easily formed and shaped, such as clay, metal (e.g., sheet metal), or other suitable materials that can be manipulated by the robotic arms to match the precise specifications outlined in the die definitions. In such embodiments, casting module 215 may control the robotic arms to ensure accurate shaping, applying the necessary forces and movements to form the substrate into the mold or die with the correct dimensions, angles, and features needed for the casting process. This automated approach allows for high precision and consistency in die creation, ensuring that the final cast object will meet the desired quality standards and functional requirements.

In embodiments, casting module 215 may also include and/or be in communication with sensors on and/or around the robotic arms to monitor the shaping process. In this manner, the sensors may provide feedback to casting module 215 and/or the robotic arms in real-time to adjust and improve accuracy. Furthermore, the die could be made to include features such as gating systems, venting, and core placements as specified in the die definitions, for efficient and accurate casting. In such embodiments, the die definitions may further include step by step instructions for the one or more robotic arms to shape the die or mold to meet the specifications of the die definitions. In embodiments, the created die or mold may be saved for use and/or re-use on a future project and/or by a third party.

In embodiments, casting module 215 may arrange for a user to obtain and/or receive dies and/or molds that have already been created or manufactured. In embodiments, the already-created dies or molds may have been previously created by casting module 215 and have been stored for future projects. In other embodiments the already-created dies or molds may have been previously created by another system and/or a third-party manufacturer. In such embodiments, casting module 215 may arrange for a user to obtain and/or receive the already-created dies or molds and may analyze and inspect the dies or molds to ensure that they meet the specifications of the die definitions. Dies or molds that do not meet the specifications of the die definitions may be cast out and/or may be altered to meet the specifications. Casting module 215 may arrange for a user to obtain and/or receive the dies and/or molds by coordinating with third-party suppliers, manufacturers, or through a direct retrieval from an existing inventory. In embodiments, this may involve managing the logistics, ensuring proper shipping, and facilitating the inspection and/or quality control processes to confirm that the dies or molds meet the required specifications.

In embodiments, casting module 215 is configured to cast at least a portion of an object that is to be 3D printed using the generated, obtained and/or received die. In other words, casting module 215 can utilize the generated, obtained, and/or received die to produce a cast object by filling the die with the appropriate casting material. Casting module 215 may use advanced additive manufacturing techniques to carefully deposit layers of material (e.g., in a layer-by-layer fashion), ensuring that the cast object conforms to the exact specifications outlined in the die definitions. In embodiments, and depending on the type of casting being performed, casting module 215 may use various materials such as metal, resin, or other suitable casting materials for casting. Furthermore, casting module 215 may be equipped with and/or in communication with sensors and/or monitoring systems to track the casting process, ensuring the material is applied correctly and that the final cast meets the required specifications. In embodiments, the sensors and/or monitoring systems may also analyze material integrity, surface finish, and dimensional accuracy.

In embodiments, the casting may be completed using a 3D printer for filling the die with the appropriate casting material. In such embodiments, the 3D printer will melt the filament from solid to liquid and will be feeding the different types of dies. For example, the 3D printer may be equipped with a nozzle having a large enough capacity to accommodate filling the cast or mold.

In embodiments, this casting process may be repeated for multiple iterations and/or batches, with the die being reused, adjusted, and/or replaced as needed to optimize production or accommodate changes in design.

In accordance with aspects of the present invention, 3D printing module 220 is further configured to print, using a three-dimensional printer, an additional portion of the object on top of and/or next to the cast portion of the object. In other words, 3D printing module 220 may 3D print additional parts and/or features of the object in a manner that integrates with the previously cast portion, to complete the object defined by the 3D print file. This process enables the creation of complex, multi-material objects or objects with varying features that cannot be easily achieved with traditional casting alone. For example, 3D printing module 220 may print a layer of material directly on top of or alongside the cast material, effectively combining additive manufacturing and casting with 3D printing to produce a more intricate and precise final object in an efficient manner. In embodiments, this capability could be particularly useful in applications where different materials with distinct properties are needed in different regions of the object, such as a metal base with a plastic or composite exterior. It could also be used to add ornamental features with a 3D printer on top of a cast object to add intricate features not capable of obtaining using casting alone.

In embodiments, 3D printing module 220 may use the same or different materials compared to those used in the casting process. 3D printing module 220 may also modify the print process dynamically to accommodate various material properties, layer bonding, and cooling conditions for optimal results. Furthermore, the combination of casting and 3D printing in this manner could improve efficiency, reduce waste, and enable faster prototyping or production of complex objects with high-performance specifications as compared to casting methods alone and/or 3D printing methods alone.

In embodiments, 3D printing module 220 may cast an additional portion (i.e., a third portion) of the object using the same and/or a different die. For example, this additional portion may be cast on top of the second portion of the object. This may be done by casting the third portion using a new die or mold that is specifically designed to integrate with the previously cast and/or printed portions. 3D printing module 220 may carefully align and position the third die or mold on top of or adjacent to the previous portions to ensure a seamless connection between them. This process allows for the progressive building of the object in multiple layers, with each portion cast or printed with high precision to form a unified final product.

In some embodiments, the additional portion (i.e., the third portion) cast by 3D printing module 220, may use a different material, which may necessitate the use of a new, modified, and/or additional die specifically designed for the different properties (e.g., temperature resistance and/or flow characteristics). This approach allows for a multi-material object to be created, with each portion of the object designed to meet specific performance criteria, such as structural strength, aesthetic appearance, or functionality. The ability to cast an additional portion using a separate die in this manner provides increased flexibility in design and production, as it enables complex geometries or designs that would be difficult to achieve with a single casting process. Moreover, it could also help streamline manufacturing by allowing for modular production of different parts of the object, which can later be integrated together, reducing the time and resources required to produce the final object.

In embodiments, 3D printing module 220 may use the sensors and/or monitoring systems to analyze material integrity, surface finish, and dimensional accuracy of the 3D object after all phases and/or zones of the object are completed. If the final object passes the inspection, the object is complete. If the final object does not pass the inspection, the object is rejected and either cast out or set aside for additional modifications.

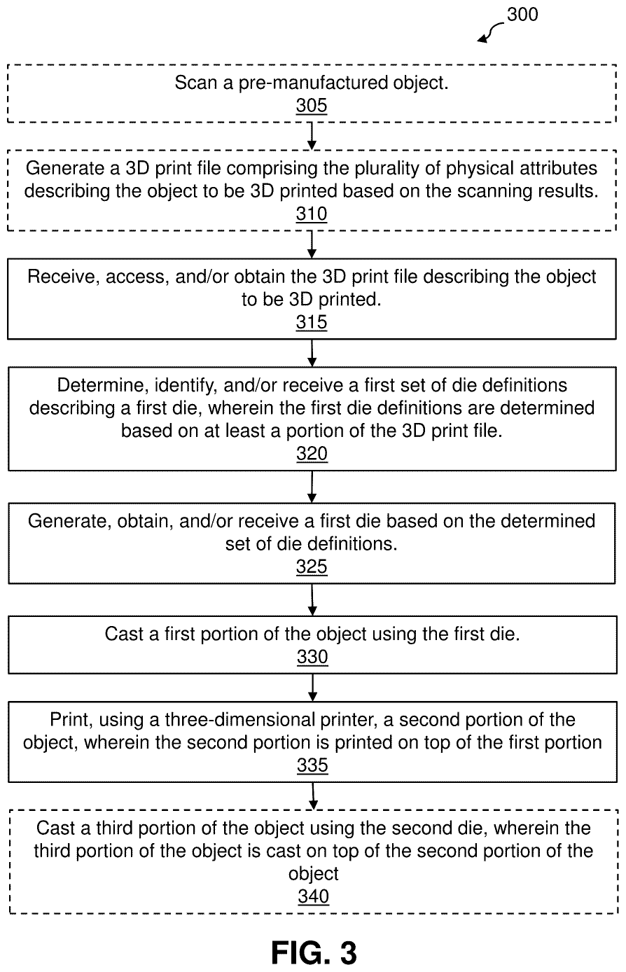

FIG. 3 shows a flow diagram of an exemplary method 300 in accordance with aspects of the present invention. Operations of the method 300 are described with reference to elements and actions depicted in and described with reference to FIG. 2.

At operation 305, the system (e.g., modeling module 210 of FIG. 2) may be optionally configured (as indicated by the dotted lines) to scan a pre-manufactured object. As provided above, scanning refers to the process of capturing the shape, dimensions, surface texture, color information, geometry accuracy, surface smoothness, surface contours, and/or other relevant physical properties of the object. Furthermore, a pre-manufactured object refers to an object that has been created, fabricated, and/or assembled prior to the scanning process. In embodiments, the pre-manufactured object may be a 3D printed object. Operation 305 may be performed in accordance with the descriptions and embodiments of modeling module 210 and with respect to FIG. 2.

At operation 310, the system (e.g., modeling module 210 of FIG. 2) may be optionally configured to generate a 3D print file comprising the plurality of physical attributes describing the object to be 3D printed based on the scanning results. In embodiments, modeling module 210 is configured to generate a 3D print file by processing the scan data to create a digital 3D model, which includes the object's shape, dimensions, surface texture, and other relevant attributes. In such embodiments, modeling module 210 converts this digital 3D model into a file format suitable for 3D printing (e.g., stereolithography file (STL), object file (OBJ), and/or additive manufacturing file (AMF)). Operation 310 may be performed in accordance with the descriptions and embodiments of modeling module 210 and with respect to FIG. 2.

At operation 315, the system (e.g., cast and 3D print server 205 of FIG. 2) is configured to receive, access, and/or obtain the 3D print file describing an object to be 3D printed. In embodiments, 3D print file describing an object to be 3D printed may be accessed or obtained at an external storage location (e.g., data source 230 and/or knowledge base 235). In embodiments, 3D print file describing an object to be 3D printed may is received from an internal location (e.g., modeling module 210 of FIG. 2). Operation 315 may be performed in accordance with the description and embodiments of mold and 3D print server 205 and with respect to FIG. 2.

At operation 320, the system (e.g., casting module 215 of FIG. 2) may be configured to determine, identify, and/or receive a set of die definitions describing a die (e.g., a mold) for casting based on at least a portion of the 3D print file. As explained above, die definitions refer to a detailed specification that describes the physical characteristics, shape, dimensions, and features of a die and/or mold used in the casting process. It may include information such as material requirements, cavity design, gating system, and other factors for creating a die that can produce the desired cast object based on the 3D model and/or a 3D print file. The die definitions may also include specific lengths, angles, tolerances, draft angles, surface finish requirements, venting designs, and core placements. These factors ensure that the die is correctly designed to produce high-quality castings that match the desired specifications and are manufacturable within the constraints of the casting process.

In embodiments, the system (e.g., casting module 215 of FIG. 2) may be configured to determine step-by-step instructions for turning a malleable substrate into a die or mold that meets the specifications of the die definitions. In other words, casting module 215 may be configured to generate a detailed process plan or workflow for manufacturing the die or mold based on the die definitions. Operation 320 may be performed in accordance with the description and embodiments of casting module 215 and with respect to FIG. 2.

At operation 325, the system (e.g., casting module 215 of FIG. 2) may be configured to generate, obtain, and/or receive a die based on the determined set of die definitions. In embodiments, the die is generated using one or more robotic arms and a malleable substrate based on the die definitions. Specifically, the robotic arms may be used to manipulate the malleable substrate by shaping it according to the die definitions. In embodiments, the malleable substrate can be a material that can be easily formed and shaped, such as clay, metal (e.g., sheet metal), or other suitable materials that can be manipulated by the robotic arms to match the precise specifications outlined in the die definitions. In such embodiments, casting module 215 may control the robotic arms to ensure accurate shaping, applying the necessary forces and movements to form the substrate into the mold or die with the correct dimensions, angles, and features needed for the casting process. As noted above, this automated approach allows for high precision and consistency in die creation, ensuring that the final cast object will meet the desired quality standards and functional requirements. Operation 325 may be performed in accordance with the description and embodiments of casting module 215 and with respect to FIG. 2.

At operation 330, the system (e.g., casting module 215 of FIG. 2) may be configured to cast at least a first portion of an object using the generated, obtained and/or received die. In other words, the generated, obtained, and/or received die(s) are used to produce a cast object by filling the die with the appropriate casting material. Advanced additive manufacturing techniques may be used to carefully deposit layers of material (e.g., in a layer-by-layer fashion), ensuring that the cast object conforms to the exact specifications outlined in the die definitions. In embodiments, and depending on the type of casting being performed, 3D printing module 220 may use various materials such as metal, resin, or other suitable casting materials for casting. Operation 330 may be performed in accordance with the description and embodiments of casting module 215 and with respect to FIG. 2.

At operation 335, the system (e.g., 3D printing module 220 of FIG. 2) may be configured to 3D print a second portion of the object. In embodiments, the system may comprise a 3D printer for performing the 3D printing tasks. In other embodiments, the system may be in electronic communication with a 3D printer such that the system may control the connected 3D printer for performing the 3D printing tasks. In additional embodiments, the 3D printed portion of the object may be on top of and/or near (e.g., next to or abutting) the portion of the object cast at operation 320. Operation 335 may be performed in accordance with the description and embodiments of 3D printing module 220 and with respect to FIG. 2.

At operation 340, the system (e.g., one or more of 3D print server 205, modeling module 210, casting module 215, and 3D printing module 220) may optionally be configured to cast a third portion of the object using a second die by performing operations 305-330 with respect to a second die. In such embodiments, the third portion of the object may be cast on top of and/or near (e.g., next to or abutting) the first and/or second portions of the object. Operation 440 may be performed in accordance with the description and embodiments of 3D print server 205, modeling module 210, casting module 215, and 3D printing module 220, and with respect to FIG. 2.

In embodiments, additional casting and 3D printing steps may be performed on top of and/or near (e.g., next to or abutting) the first, second, and/or third portions of the object. Indeed, additional layers may be added to the 3D object using the operations 305-335.

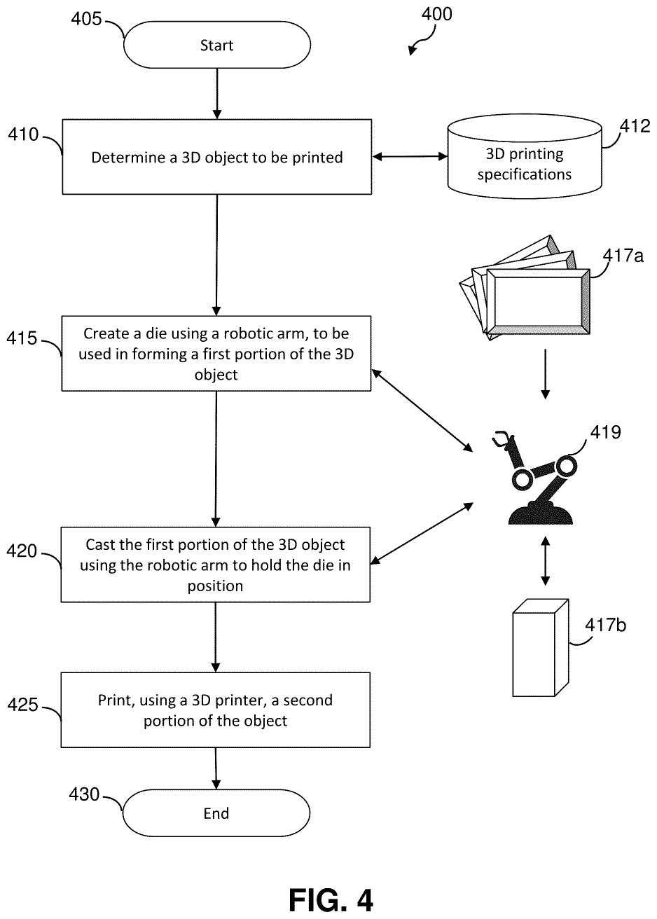

FIG. 4 shows a flowchart of exemplary method 400 in accordance with aspects of the present invention. Steps of the method (also referred to as operations) may be carried out in the environment of FIG. 2 and are described with reference to elements depicted in FIGS. 2 and 3.

At operation 405, cast and 3D print server 205 of FIG. 2 is configured to initialize method 400. At operation 410, modeling module 210 is configured to determine a 3D object to be printed. In embodiments, a 3D object to be printed may be determined based on a scanned pre-manufactured object, as described above with respect to FIG. 2. In other embodiments, the 3D object may be determined from a model, drawing, and/or rendering of a 3D object. Such models, drawings, and/or renderings may be obtained from 3D print specifications 410.

In embodiments, 3D printing specifications 412 may comprise a database, a knowledge base, and/or a repository. In embodiments, 3D printing specifications 412 may store specifications for printing 3D objects. For example, 3D printing specifications 412 may include information such as material types, printing methods, layer resolutions, and other relevant parameters needed to accurately print a 3D object. The specifications may also contain predefined templates for common object types and/or industry-specific guidelines, enabling modeling module 210 to efficiently determine the appropriate 3D object for printing. This database, knowledge base, and/or repository could be continuously updated based on new materials and/or technologies, providing modeling module 210 with up-to-date printing options and configurations.

In some embodiments, the 3D object to be printed may be selected at operation 410 based on user input, such as selecting a design from a library or uploading a custom 3D model. Alternatively, the modeling module 210 could generate a 3D object based on a combination of design parameters, functional requirements, and the intended casting or manufacturing process. In embodiments, operation 410 may be performed in accordance with operations 305-315 of FIG. 3 and in accordance with the description of modeling module 210 of FIG. 2.

At operation 415, casting module 215 of FIG. 2 is configured to create a die using robotic arm 419, to be used in forming a first portion of the 3D object. Specifically, casting module 215 may comprise robotic arm 419 or it may be in electronic communication with robotic arm 419. In either case, robotic arm 419 may be instructed to retrieve a malleable substrate 417a, and turn the malleable substrate 417a into a die or mold 417b. In other words, robotic arm 419 be used to manipulate the malleable substrate by shaping it according to die definitions (e.g., specifications). In embodiments, the malleable substrate 417a can be a material that can be easily formed and shaped, such as clay, metal (e.g., sheet metal), or other suitable materials that can be manipulated by robotic arm 419 to match the precise specifications outlined in the die definitions. In such embodiments, casting module 215 may control robotic arm 419 to ensure accurate shaping, applying the necessary forces and movements to form malleable substrate 471a into the die or mold 417b with the correct dimensions, angles, and features needed for the casting process. This automated approach allows for high precision and consistency in die creation, ensuring that the final cast object will meet the desired quality standards and functional requirements. In embodiments, operation 415 may be performed in accordance with operations 320-325 of FIG. 3 and in accordance with the description of casting module 215 of FIG. 2.

At operation 420, casting module 215 of FIG. 2 is configured to cast the first portion of the 3D object using robotic arm 419 to hold the die or mold 417b in position. In other words, casting module 215 can utilize the generated, obtained, and/or received die to produce a cast object by filling the die with the appropriate casting material while robotic arm 419 holds the die or mold in place. In such embodiments, robotic arm 419 may grip the die after it is formed. The 3D printing system may heat the filament material and will pour the material in the die, allowing the material to solidify and join to the 3D object. Upon material solidification, robotic arm 419 may remove the die or mold so that the die or mold can be used on different portion of the object or another object during the manufacturing process.

In embodiments, casting module 215 may use advanced additive manufacturing techniques to carefully deposit layers of material (e.g., in a layer-by-layer fashion), ensuring that the cast object conforms to the exact specifications outlined in the die definitions. In embodiments, and depending on the type of casting being performed, casting module 215 may use various materials such as metal, resin, or other suitable casting materials for casting. In embodiments, casting module 215 and/or robotic arm 419 may be equipped with and/or in communication with sensors and/or monitoring systems to track the casting process, ensuring the material is applied correctly and that the final cast meets the required specifications. In embodiments, the sensors and/or monitoring systems may also analyze material integrity, surface finish, and dimensional accuracy of the cast. In embodiments, operation 420 may be performed in accordance with operation 330 of FIG. 3 and in accordance with the description of casting module 215 of FIG. 2.

At operation 425, 3D printing module 220 of FIG. 2 is configured to print, using a 3D printer, a second portion of the object. In other words, 3D printing module 220 may 3D print additional parts and/or features of the object in a manner that integrates with the cast portion of the object from operation 420. This process enables the creation of complex, multi-material objects or objects with varying features that cannot be easily achieved with traditional casting alone. For example, 3D printing module 220 may print a layer of material directly on top of or alongside the cast material, effectively combining additive manufacturing and casting with 3D printing to produce a more intricate and precise final object in an efficient manner. In embodiments, this capability could be particularly useful in applications where different materials with distinct properties are needed in different regions of the object, such as a metal base with a plastic or composite exterior. It could also be used to add ornamental features with a 3D printer on top of a cast object to add intricate features not capable of obtaining using casting alone. In embodiments, operation 425 may be performed in accordance with operation 335 of FIG. 3 and in accordance with the description of 3D printing module 220 of FIG. 2. At operation 430, 3D print server 205 terminates method 400.

In embodiments, a service provider could offer to perform the processes described herein. In this case, the service provider can create, maintain, deploy, support, etc., the computer infrastructure that performs the process steps in accordance with aspects of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In additional embodiments, implementations provide a computer-implemented method, via a network. In this case, a computer infrastructure, such as computer 101 of FIG. 1, can be provided and one or more systems for performing the processes in accordance with aspects of the invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes in accordance with aspects of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
receiving a three-dimensional (3D) print file comprising a plurality of physical attributes describing an object to be 3D printed;
determining a first set of die definitions describing a first die, wherein the first die definitions are determined based on at least a portion of the 3D print file;
obtaining a first die based on the determined first set of die definitions;
casting a first portion of the object using the first die; and
printing, using a 3D printer, a second portion of the object, wherein the second portion is printed on top of the first portion.

2. The method of claim 1, further comprising:
scanning a pre-manufactured object; and
generating the 3D print file comprising the plurality of physical attributes describing the object to be 3D printed based on the scanning.

3. The method of claim 1, further comprising removing the first die from the first portion of the object to be 3D printed.

4. The method of claim 1, wherein obtaining the first die comprises generating the first die by bending a substrate into a form that meets the determined set of die definitions.

5. The method of claim 4, wherein the substrate comprises a metal, and wherein the bending the substrate into form is performed by at least one robotic arm.

6. The method of claim 1, further comprising determining a second set of die definitions describing a second die, wherein the second die definitions are determined based on at least a portion of the 3D print file.

7. The method of claim 6, further comprising:
obtaining a second die based on the determined second set of die definitions; and
casting a third portion of the object using the second die, wherein the third portion of the object is cast on top of the second portion of the object.

8. The method of claim 7, further comprising scanning at least one of the first portion, the second portion, and the third portion to ensure that the object meets the plurality of physical attributes.

9. The method of claim 1, wherein the casting the first portion of the object using the first die comprises filling the first die with a melted filament using the 3D printer.

10. The method of claim 1, wherein obtaining the first die comprises generating the first die by 3D printing a substrate into a form that meets the determined set of die definitions.

11. A computer program product comprising:
one or more computer-readable storage media; and
program instructions stored on the one or more computer-readable storage media to perform operations comprising:
receiving a three-dimensional (3D) print file comprising a plurality of physical attributes describing an object to be 3D printed;
determining a first set of die definitions describing a first die, wherein the first die definitions are determined based on at least a portion of the 3D print file;
obtaining a first die based on the determined first set of die definitions;
casting a first portion of the object using the first die; and
printing, using a 3D printer, a second portion of the object, wherein the second portion is printed on top of the first portion.

12. The computer program product of claim 11, wherein the operations further comprise:
scanning a pre-manufactured object; and
generating the 3D print file comprising the plurality of physical attributes describing the object to be 3D printed based on the scanning.

13. The computer program product of claim 11, wherein obtaining the first die comprises generating the first die by bending a substrate into a form that meets the determined set of die definitions, and wherein the substrate comprises a metal, and wherein the bending the substrate into form is performed by at least one robotic arm.

14. The computer program product of claim 11, wherein the operations further comprise determining a second set of die definitions describing a second die, wherein the second die definitions are determined based on at least a portion of the 3D print file.

15. The computer program product of claim 14, wherein the operations further comprise:
obtaining a second die based on the determined second set of die definitions; and
casting a third portion of the object using the second die, wherein the third portion of the object is cast on top of the second portion of the object.

16. A computer system comprising:
a processor set;
one or more computer-readable storage media; and
program instructions stored on the one or more computer-readable storage media to cause the processor set to perform operations comprising:
receiving a three-dimensional (3D) print file comprising a plurality of physical attributes describing an object to be 3D printed;
determining a first set of die definitions describing a first die, wherein the first die definitions are determined based on at least a portion of the 3D print file;
obtaining a first die based on the determined first set of die definitions;
casting a first portion of the object using the first die; and
printing, using a 3D printer, a second portion of the object, wherein the second portion is printed on top of the first portion.

17. The computer system of claim 16, wherein the operations further comprise:
scanning a pre-manufactured object; and
generating the 3D print file comprising the plurality of physical attributes describing the object to be 3D printed based on the scanning.

18. The computer system of claim 16, wherein obtaining the first die comprises generating the first die by bending a substrate into a form that meets the determined set of die definitions, and wherein the substrate comprises a metal, and wherein the bending the substrate into form is performed by at least one robotic arm.

19. The computer system of claim 16, wherein the operations further comprise determining a second set of die definitions describing a second die, wherein the second die definitions are determined based on at least a portion of the 3D print file.

20. The computer system of claim 19, wherein the operations further comprise:
obtaining a second die based on the determined second set of die definitions; and
casting a third portion of the object using the second die, wherein the third portion of the object is cast on top of the second portion of the object.
